(19) United States
(12) Patent Application Publication
(10) Pub. No.: US 2011/0190128 A1
(43) Pub. Date: Aug. 4, 2011

(54) Process for Preparing Stable Solids Formulations of Sulfonamides

(75) Inventors: Arno RATSCHINSKI, Frankfurt (DE); Hans-Peter KRAUSE, Hofheim (DE)

(73) Assignee: BAYER CROPSCIENCE AG, Monheim (DE)

(21) Appl. No.: 13/020,412

(22) Filed: Feb. 3, 2011

(30) Foreign Application Priority Data
Feb. 4, 2010 (EP) 10152584.8

(51) Int. Cl. A01N 25/32; A01N 43/66; A01N 43/88; A01P 13/00

(52) U.S. Cl. 504/103; 504/212; 504/214; 504/133

(57) ABSTRACT

The present invention relates to a process for preparing storage-stable solid herbicide formulations which comprise herbicidally active compounds from the group of the sulfonamides and their salts, in particular phenylsulfonamides, such as phenylsulfonylaminocarbonyltriazolinones or phenylsulfonylureas, heteroarylsulfonamides and other sulfonamides and their salts.

### CROSS REFERENCE TO RELATED APPLICATIONS

This application claims priority from EP10152584.8 filed Feb. 4, 2010, the content of which is incorporated herein by reference in its entirety.

### BACKGROUND

1. Field of the Invention

The present invention relates to the field of crop protection compositions. In particular, the invention relates to a process for preparing storage-stable, solid herbicide formulations which comprise herbicidally active compounds from the group of the sulfonamides and their salts, in particular phenylsulfonamides (such as phenylsulfonylaminocarbonyltriazolinones or phenylsulfonylureas), heteroarylsulfonamides and other sulfonamides and their salts.

2. Description of Related Art

In general, active compounds for crop protection are not employed in their pure form. Depending on the area of use and the type of use, and on physical, chemical and biological parameters, the active compound is used as an active compound formulation in a mixture with customary auxiliaries and additives. Combinations with further active compounds for widening the activity spectrum and/or for protecting crop plants (for example by safeners, antidotes) are also known.

Formulations of active compounds for crop protection should generally have high chemical and physical stability, should be easy to apply and easy to use, and should have broad biological action combined with high selectivity.

Solid formulations of active compounds from the group of the sulfonylureas are known per se, for example from WO-A-97/10714, WO-A-02/017718, WO-A-98/042192, WO-A-98/034482 and EP-A 0 764 404.

Herbicidally active compounds from the group of the sulfonamides generally have a high level of chemical reactivity and exhibit a tendency toward chemical degradation, e.g., by hydrolysis. This must be considered critical in relation to sufficient storage stability (i.e., shelf life) in the formulations, and account must also be taken, additionally, of the anticipated storage temperatures in each of the intended markets. Such degradation processes may also occur even during the preparation of the formulations, and so the parameters utilized in their preparation are also critical. Accordingly, in WO-A-02/017718, only those suspensions which before the drying step are set to a pH level of between 6.5 and 8 are described as being suitable precursors for preparing solid formulations comprising sulfonylureas. At lower levels, degradation would occur, while at higher levels, highly viscous suspensions would be formed which it would no longer be possible to process. Data demonstrating this effect are shown for suspensions comprising tritosulfuron or mixtures of tritosulfuron and dicamba as herbicidally active compounds.

Nevertheless, there is a need to carry out such processes even at relatively high pH levels, according to the identity and physicochemical properties of the ingredients desired in the formulation.

### SUMMARY

The object of the present invention, therefore, was to provide a process which enables the preparation of herbicidal solid formulations starting from suspensions having a pH level of more than 8, the resulting solid formulations exhibiting high storage stability in addition to a continued high biological effectiveness and crop-plant tolerance.

This object is achieved by the process of the invention and the water-dispersible solid formulations prepared with said process.

The formulations prepared in accordance with the invention comprise
(a) one or more active compounds from the group of the sulfonamides and their salts,
(b) one or more carrier materials,
(c) one or more wetting agents, preferably from the group of the naphthalene sulfonic acids and the group of the sulfosuccinic acid derivatives and also the salts of these groups,
(d) further customary auxiliaries and additives,
(e) optionally one or more safeners,
   and optionally
   (e-1) solvents,
   (e-2) emulsifiers and
   (e-3) carrier materials
   that are optionally needed for the addition of safener,
(f) optionally one or more agrochemically active compounds different from (a) and (e).

The process according to the invention for preparing these formulations comprises the following steps:
1. preparing a suspension of components (a) to (f), where needed,
2. setting the desired pH level by addition of base,
3. drying the suspension,
   the pH level being set in accordance with the invention in step 2 to a level of 8.1 to 10, preferably 8.5 to 9.5. Drying may take place in principle by any suitable method by which a solid can be obtained from a suspension, preferably by fluidized bed granulation or spray drying. The preference ranges indicated in the further course of the description for the various components of the suspension relate also in the same way to the use of the components in the process according to the invention.

### DETAILED DESCRIPTION OF A PREFERRED EMBODIMENT

One preferred embodiment of the present invention is the preparation of solid formulations comprising precisely one active ingredient from the group of the sulfonamides and their salts (component (a)).

Another preferred embodiment of the present invention lies in the preparation of solid formulations comprising two or more active compounds from the group of the sulfonamides and their salts (component (a)), with particular preference comprising two active compounds from the group of the sulfonamides and their salts (component (a)).

A further preferred embodiment of the present invention lies in the preparation of solid formulations comprising two or more active compounds from the group of the sulfonamides and their salts (component (a)) and one or more safeners (component (e)) and the solvents (component (e-1)), emulsifiers (component (e-2)) and carrier materials (component (e-3)) that are optionally needed for the addition of safener.

Preferred sulfonamides (component (a)) are phenylsulfonamides, such as phenylsulfonylaminocarbonyltriazolinones or phenylsulfonylureas, heteroarylsulfonamides and other sulfonamides, such as amidosulfuron, and their salts. Generally not suitable for the process according to the invention is tritosulfuron and its salts. Preferred phenylsulfonamides are compounds from the group of the phenylsulfonylaminocarbonyltriazolinones or the phenylsulfonylureas. The term phenylsulfonylureas is to be understood as including those sulfonylureas in which the phenyl group is attached via a spacer such as CH₂, O or NH to the sulfone group (SO₂). Examples of phenylsulfonylaminocarbonyltriazolinones are flucarbazone, propoxycarbazone or thiocarbazone and/or their salts. The sulfonamides are commercially available and/or can be prepared by known processes.

Suitable phenylsulfonamides are for example phenylsulfonamides of the formula (I) and/or salts thereof,

R^{α}-(A)ₘ-SO₂—NR^{β}—CO—(NR^{γ})ₙ—R^{δ} (I)

in which
R^{α} is an unsubstituted or substituted phenyl radical, where the phenyl radical including substituents has 1-30 carbon atoms, preferably 1-20 carbon atoms,
R^{β} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
R^{γ} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
A is CH₂, O or NH, preferably O,
m is zero or 1,
n is zero or 1, preferably 1, and
R^{δ} is a heterocyclic radical, such as a pyrimidyl radical, a triazinyl radical or a triazolinone radical.

Preferred phenylsulfonamides are phenylsulfonylureas, for example phenylsulfonylureas of the formula (II) and/or salts thereof,

R^{α}-(A)ₘ-SO₂—NR^{β}—CO—NR^{γ}—R^{δ} (II)

in which
R^{α} is an unsubstituted or substituted phenyl radical, where the phenyl radical including substituents has 1-30 carbon atoms, preferably 1-20 carbon atoms,
R^{β} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
R^{γ} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
A is CH₂, O or NH, preferably O,
m is zero or 1, and
R^{δ} is a heterocyclic radical, such as a pyrimidyl radical or a triazinyl radical.

Preference is given to phenylsulfonylureas of the formula (III) and/or salts thereof,

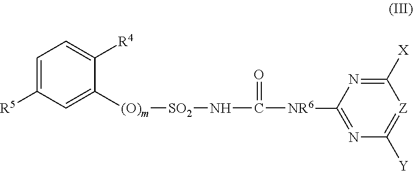

in which
R⁴ is halogen, C₁-C₄-alkoxy, preferably C₂-C₄-alkoxy, or CO—R^{a}, where R^{a} is OH, C₁-C₄-alkoxy or NR^{b}R^{c}, where R^{b} and R^{c} are identical or different and independently of one another are H or C₁-C₄-alkyl,
R⁵ is halogen, preferably iodine, or (A)ₙ-NR^{d}R^{e} where n is zero or 1, A is a group CR′R″ in which R′ and R″ independently of one another are identical or different radicals from the group consisting of H and C₁-C₄-alkyl, R^{d} is H or C₁-C₄-alkyl and R^{e} is an acyl radical, such as formyl, or C₁-C₄-alkylsulfonyl, and in the case that R⁴ is C₁-C₄-alkoxy, preferably C₂-C₄-alkoxy, or halogen, R⁵ may also be H,
R⁶ is H or C₁-C₄-alkyl,
m is zero or 1,
X and Y are identical or different and independently of one another are halogen or NR′R″, where R′ and R″ are identical or different and are H or C₁-C₄-alkyl, or C₁-C₆-alkyl, C₁-C₆-alkoxy, C₁-C₆-alkylthio, C₃-C₆-cycloalkyl, C₂-C₆-alkenyl, C₂-C₆-alkynyl, C₃-C₆-alkenyloxy or C₃-C₆-alkynyloxy, where each of the eight lastmentioned radicals is unsubstituted or substituted by one or more radicals from the group consisting of halogen, C₁-C₄-alkoxy and C₁-C₄-alkylthio, preferably C₁-C₄-alkyl or C₁-C₄-alkoxy, and
Z is CH or N.

Particular preference is given to phenylsulfonylureas of the formula (III) and/or salts thereof, in which
a) R⁴ is CO—(C₁-C₄-alkoxy), R⁵ is halogen, preferably iodine, or R⁵ is CH₂—NHR^{e}, where R^{e} is an acyl radical, preferably C₁-C₄-alkylsulfonyl, and m is zero,
b) R⁴ is CO—N(C₁-C₄-alkyl)₂, R⁵ is NHR^{e}, where R^{e} is an acyl radical, preferably formyl, and m is zero, or
c) R⁴ is C₂-C₄-alkoxy, R⁵ is H and m is 1, or
d) R⁴ is halogen, R⁵ is H and m is zero.

Typical phenylsulfonylureas are, inter alia, the compounds listed below and their salts, such as the sodium salts: bensulfuron-methyl, chlorimuron-ethyl, chlorsulfuron, cinosulfuron, cyclosulfamuron, ethametsulfuron-methyl, ethoxysulfuron and its sodium salt, metsulfuron-methyl, oxasulfuron, primisulfuron-methyl, prosulfuron, sulfometuron-methyl, triasulfuron, tribenuron-methyl, triflusulfuron-methyl, tritosulfuron, iodosulfuron-methyl and its sodium salt, mesosulfuron-methyl and its sodium salt, foramsulfuron and its sodium salt, and 2-iodo-N-[(4-methoxy-6-methyl-1,3,5-triazin-2-yl)carbamoyl]benzenesulfonamide and its sodium salt.

Particularly preferred phenylsulfonamides are: iodosulfuron-methyl and its sodium salt, mesosulfuron-methyl and its sodium salt, foramsulfuron and its sodium salt, flucarbazone and its sodium salt, propoxycarbazone and its sodium salt, methyl 4-[(4,5-di hydro-3-methoxy-4-methyl-5-oxo-1H-1,2,4-triazol-1-yl)carboxamido-sulfonyl]-5-methylthiophene-3-carboxylate and its sodium salt, and ethoxysulfuron and its sodium salt, metsulfuron-methyl and its sodium salt, tribenuron-methyl and its sodium salt, chlorsulfuron and its sodium salt, and 2-iodo-N-[(4-methoxy-6-methyl-1,3,5-triazin-2-yl)carbamoyl]benzenesulfonamide and its sodium salt.

The active compounds listed above are known, for example, from “The Pesticide Manual”, 12th edition, The British Crop Protection Council (2000).

Suitable heteroarylsulfonamides are, for example, compounds from the group of the heteroarylsulfonylaminocarbonyltriazolinones or heteroarylsulfonylureas, preferably from the group of the heteroarylsulfonylureas. The term “heteroarylsulfonylureas” is to be understood as including those sulfonylureas in which the heteroaryl group is attached via a spacer such as CH₂, O or NH to the sulfone group (SO₂).

Suitable heteroarylsulfonamides are, for example, sulfonamides of the formula (IV) and/or salts thereof,

R^{α′}-(A′)_{m′}-SO₂—NR^{β′}—CO—(NR^{γ}′)_{n′}—R^{δ′} (IV)

in which
R^{α′} is an unsubstituted or substituted heteroaryl radical, where the heteroaryl radical including substituents has 1-30 carbon atoms, preferably 1-20 carbon atoms,
R^{β′} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
R^{γ′} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
A′ is CH₂, O or NH, preferably O,
m′ is zero or 1,
n′ is zero or 1, preferably 1, and
R^{δ′} is a heterocyclic radical, such as a pyrimidyl radical, a triazinyl radical or a triazolinone radical.

Preferred heteroarylsulfonamides are heteroarylsulfonylureas, for example sulfonylureas of the formula (V) and/or salts thereof,

R^{α′}-(A′)_{m′}-SO₂—NR^{β′}—CO—NR^{γ′}—R^{δ′} (V)

in which
R^{α′} is an unsubstituted or substituted heteroaryl radical, where the heteroaryl radical including substituents has 1-30 carbon atoms, preferably 1-20 carbon atoms,
R^{β′} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
R^{γ′} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
A′ is CH₂, O or NH, preferably O,
m′ is zero or 1, and
R^{δ′} is a heterocyclic radical, such as a pyrimidyl radical or a triazinyl radical.

Particular preference is given to heteroarylsulfonamides of the formula (VI) below,

R^{α′}—SO₂—NH—CO—(NR^{γ}′)_{n′}—R^{δ}′ (VI)

in which
R^{α}′ is a substituted heteroaryl radical such as substituted pyridyl, thienyl, pyrazolyl or imidazolyl,
R^{γ}′ is H, (C₁-C₃)-alkyl, unsubstituted or substituted by halogen (F, C, Br, I) or halo-(C₁-C₃)-alkoxy, preferably H or methyl,
   for n′ as 1, R^{δ}′ is a pyrimidinyl radical or a triazinyl radical, preferably

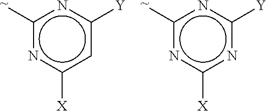

and for n′ as zero, R^{δ}′ is a triazolinone radical, preferably

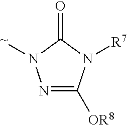

R⁷ is (C₁-C₁₀)-alkyl which is optionally substituted by halogen (F, Cl, Br, I) or (C₁-C₃)-haloalkyl,
R⁸ is (C₁-C₁₀)alkyl which is optionally substituted by halogen (F, Cl, Br, I) or (C₁-C₃)-haloalkyl,
X and Y are identical or different and independently of one another are halogen or NR′R″, where R′ and R″ are identical or different and are H or C₁-C₄-alkyl, or C₁-C₆-alkyl, C₁-C₆-alkoxy, C₁-C₆-alkylthio, C₃-C₆-cycloalkyl, C₂-C₆-alkenyl, C₂-C₆-alkynyl, C₃-C₆-alkenyloxy or C₃-C₆-alkynyloxy, where each of the eight lastmentioned radicals is unsubstituted or substituted by one or more radicals from the group consisting of halogen, C₁-C₄-alkoxy and C₁-C₄-alkylthio, preferably C₁-C₄-alkyl or C₁-C₄-alkoxy.

Particularly preferably, R^{α}′ is

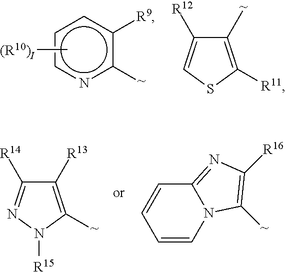

in which
R⁹ is (C₁-C₆)-alkyl, (C₁-C₆)-alkoxy, (C₂-C₆)-alkenyloxy, (C₂-C₆)-alkynyloxy, (C₁-C₆)-alkylsulfonyl, (C₁-C₆)-alkylcarbonyl, (C₁-C₆)-alkoxycarbonyl, (C₂-C₆)-alkenyloxycarbonyl, (C₂-C₆)-alkynyloxycarbonyl, CONR′R″, halo-(C₁-C₆)-alkyl, halo-(C₁-C₆)-alkoxy, halo-(C₂-C₆)-alkenyloxy, halo-(C₂-C₆)-alkynyloxy, halo-(C₁-C₆)-alkylsulfonyl, halo-(C₁-C₆)-alkylcarbonyl, halo-(C₁-C₆)-alkoxycarbonyl, halo-(C₂-C₆)-alkenyloxycarbonyl, halo-(C₂-C₆)-alkynyloxycarbonyl,
R¹⁰ is H, (C₁-C₃)-alkyl, (C₁-C₃)-alkoxy, halo-(C₁-C₃)-alkyl, halo-(C₁-C₃)-alkoxy or halogen (F, Cl, Br, I),
I is zero or 1,
R¹¹ is (C₁-C₆)-alkyl, (C₁-C₆)-alkoxy, (C₂-C₆)-alkenyloxy, (C₂-C₆)-alkynyloxy, (C₁-C₆)-alkylsulfonyl, (C₁-C₆)-alkylcarbonyl, (C₁-C₆)-alkoxycarbonyl, (C₂-C₆)-alkenyloxycarbonyl, (C₂-C₆)-alkynyloxycarbonyl, halo-(C₁-C₆)-alkyl, halo-(C₁-C₆)-alkoxy, halo-(C₂-C₆)-alkenyloxy, halo-(C₂-C₆)-alkynyloxy, halo-(C₁-C₆)-alkylsulfonyl, halo-(C₁-C₆)-alkylcarbonyl, halo-(C₁-C₆)-alkoxycarbonyl, halo-(C₂-C₆)-alkenyloxycarbonyl, halo-(C₂-C₆)-alkynyloxycarbonyl, CONR′R″,
R¹² is halogen (F, Cl, Br, I), (C₁-C₆)-alkyl, (C₁-C₆)-alkoxy, (C₁-C₆)-alkylsulfonyl, (C₁-C₆)-alkoxycarbonyl, (C₂-C₆)-alkenyloxycarbonyl, (C₂-C₆)-alkynyloxycarbonyl, halo-(C₁-C₆)-alkyl, halo-(C₁-C₆)-alkoxy, halo-(C₁-C₆)-alkylsulfonyl, halo-(C₁-C₆)-alkoxycarbonyl, halo-(C₂-C₆)-alkenyloxycarbonyl, halo-(C₂-C₆)-alkynyloxycarbonyl,
R¹³ is (C₁-C₆)-alkoxycarbonyl, (C₂-C₆)-alkenyloxycarbonyl, (C₂-C₆)-alkynyloxycarbonyl, (C₁-C₆)-alkyl, (C₁-C₆)-alkoxy, (C₁-C₆)-alkylsulfonyl, halo-(C₁-C₆)-alkoxycarbonyl, halo-(C₂-C₆)-alkenyloxycarbonyl, halo-(C₂-C₆)-alkynyloxycarbonyl, halo-(C₁-C₆)-alkyl, halo-(C₁-C₆)-alkoxy, halo-(C₁-C₆)-alkylsulfonyl, halogen (F, Cl, Br, I), CONR′R″, or R¹³ is a heterocyclic ring, which may be saturated, unsaturated or aromatic and which preferably contains 4-6 ring atoms and one or more heteroatoms from the group consisting of N, O and S and which may be unsubstituted or substituted by one or more substituents, preferably from the group consisting of (C₁-C₃)-alkyl, (C₁-C₃)-alkoxy, halo-(C₁-C₃)-alkyl, halo-(C₁-C₃)-alkoxy and halogen, particularly preferably

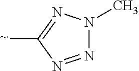

R¹⁴ is H, halogen (F, C, Br, I), (C₁-C₆)-alkyl, halo-(C₁-C₆)-alkyl,
R¹⁵ is H, (C₁-C₆)-alkyl, halo-(C₁-C₆)-alkyl,
R¹⁶ is (C₁-C₆)-alkyl, (C₁-C₆)-alkoxy, (C₂-C₆)-alkenyloxy, (C₂-C₆)-alkynyloxy, (C₁-C₆)-alkylsulfonyl, (C₁-C₆)-alkylcarbonyl, (C₁-C₆)-alkoxycarbonyl, (C₂-C₆)-alkenyloxycarbonyl, (C₂-C₆)-alkynyloxycarbonyl, halo-(C₁-C₆)-alkyl, halo-(C₁-C₆)-alkoxy, halo-(C₂-C₆)-alkenyloxy, halo-(C₂-C₆)-alkynyloxy, halo-(C₁-C₆)-alkylsulfonyl, halo-(C₁-C₆)-alkylcarbonyl, halo-(C₁-C₆)-alkoxycarbonyl, halo-(C₂-C₆)-alkenyloxycarbonyl, halo-(C₂-C₆)-alkynyloxycarbonyl, CONR′R″, in particular SO₂-ethyl, and
R′ and R″ independently of one another are H, (C₁-C₆)-alkyl, halo-(C₁-C₆)-alkyl, (C₂-C₆)-alkenyl, (C₂-C₆)-haloalkenyl, (C₂-C₆)-alkynyl, (C₂-C₆)-haloalkynyl, or NR′R″ forms a heterocyclic ring which may be saturated, unsaturated or aromatic and which preferably contains 4-6 ring atoms and one or more heteroatoms from the group consisting of N, O and S and which may be unsubstituted or substituted by one or more substituents, preferably from the group consisting of (C₁-C₃)-alkyl, (C₁-C₃)-alkoxy, halo-(C₁-C₃)-alkyl, halo-(C₁-C₃)-alkoxy and halogen.

Particularly preferred heteroarylsulfonylureas are, for example, nicosulfuron and its salts, such as the sodium salt, rimsulfuron and its salts, such as the sodium salt, thifensulfuron-methyl and its salts, such as the sodium salt, pyrazosulfuron-ethyl and its salts, such as the sodium salt, flupyrsulfuron-methyl and its salts, such as the sodium salt, sulfosulfuron and its salts, such as the sodium salt, trifloxysulfuron and its salts, such as the sodium salt, azimsulfuron and its salts, such as the sodium salt, flazasulfuron and its salts, such as the sodium salt, flucetosulfuron and its salts, such as the sodium salt, and 3-(5,6-dihydro-1,4,2-dioxazin-3-yl)-N-[(4,6-dimethoxypyrimidin-2-yl)carbamoyl]pyridine-2-sulfonamide and its sodium salt.

The active compounds listed above are known, for example, from “The Pesticide Manual”, 12th edition, The British Crop Protection Council (2000).

For the purpose of the present invention, the sulfonamides (component (a)) contained in the solid, water-dispersible formulations according to the invention are in each case to be understood as meaning all use forms, such as acids, esters, salts and isomers, such as stereoisomers and optical isomers. Thus, in addition to neutral compounds, their salts with inorganic and/or organic counterions are in each case meant to be included. Thus, sulfonamides are capable of forming salts, for example, in which the hydrogen of the —SO₂—NH group is replaced by an agriculturally suitable cation. These salts are, for example, metal salts, in particular alkali metal salts or alkaline earth metal salts, in particular sodium and potassium salts, or else ammonium salts or salts with organic amines. Salt formation may also take place by addition of an acid to basic groups, such as, for example, amino and alkylamino. Acids suitable for this purpose are strong inorganic and organic acids, for example HCl, HBr, H₂SO₄ or HNO₃. Preferred esters are the alkyl esters, in particular the C₁-C₁₀-alkyl esters, such as methyl esters.

Whenever the term “acyl radical” is used in the abovementioned description, this means the radical of an organic acid which is formally formed by removing an OH group from the organic acid, for example the radical of a carboxylic acid and radicals of acids derived therefrom, such as thiocarboxylic acid, unsubstituted or N-substituted iminocarboxylic acids or the radicals of carbonic monoesters, unsubstituted or N-substituted carbaminic acids, sulfonic acids, sulfinic acids, phosphonic acids, phosphinic acids.

An acyl radical is preferably formyl or acyl from the group consisting of CO—R^{z}, CS—R^{z}, CO—OR^{z}, CS—OR^{z}, CS—SR^{z}, SOR^{z} and SO₂R^{z}, where R^{z} is in each case a C₁-C₁₀-hydrocarbon radical, such as C₁-C₁₀-alkyl or C₆-C₁₀-aryl, which is unsubstituted or substituted, for example by one or more substituents from the group consisting of halogen, such as F, Cl, Br, I, alkoxy, haloalkoxy, hydroxyl, amino, nitro, cyano and alkylthio, or R^{z} is aminocarbonyl or aminosulfonyl, where the two lastmentioned radicals are unsubstituted, N-monosubstituted or N,N-disubstituted, for example by substituents from the group consisting of alkyl and aryl.

Acyl is, for example, formyl, haloalkylcarbonyl, alkylcarbonyl, such as (C₁-C₄)-alkylcarbonyl, phenylcarbonyl, where the phenyl ring may be substituted, or alkyloxycarbonyl, such as (C₁-C₄)-alkyloxycarbonyl, phenyloxycarbonyl, benzyloxycarbonyl, alkylsulfonyl, such as (C₁-C₄)-alkylsulfonyl, alkylsulfinyl, such as C₁-C₄-(alkylsulfinyl), N-alkyl-1-iminoalkyl, such as N—(C₁-C₄)-1-imino-(C₁-C₄)-alkyl, and other radicals of organic acids.

A hydrocarbon radical is a straight-chain, branched or cyclic and saturated or unsaturated aliphatic or aromatic hydrocarbon radical, for example alkyl, alkenyl, alkynyl, cycloalkyl, cycloalkenyl or aryl.

A hydrocarbon radical has preferably 1 to 40 carbon atoms, with preference 1 to 30 carbon atoms; with particular preference, a hydrocarbon radical is alkyl, alkenyl or alkynyl having up to 12 carbon atoms or cycloalkyl having 3, 4, 5, 6 or 7 ring atoms or phenyl.

Aryl is a mono-, bi- or polycyclic aromatic system, for example phenyl, naphthyl, tetrahydronaphthyl, indenyl, indanyl, pentalenyl, fluorenyl and the like, preferably phenyl.

A heterocyclic radical or ring (heterocyclyl) can be saturated, unsaturated or heteroaromatic and unsubstituted or substituted; it preferably contains one or more heteroatoms in the ring, preferably from the group consisting of N, O and S; it is preferably an aliphatic heterocyclyl radical having 3 to 7 ring atoms or a heteroaromatic radical having 5 or 6 ring atoms and contains 1, 2 or 3 heteroatoms. The heterocyclic radical can, for example, be a heteroaromatic radical or ring (heteroaryl), such as, for example, a mono-, bi- or polycyclic aromatic system in which at least one ring contains one or more heteroatoms, for example pyridyl, pyrimidinyl, pyridazinyl, pyrazinyl, triazinyl, thienyl, thiazolyl, oxazolyl, furyl, pyrrolyl, pyrazolyl and imidazolyl, or it is a partially or fully hydrogenated radical, such as oxiranyl, oxetanyl, pyrrolidyl, piperidyl, piperazinyl, triazolyl, dioxolanyl, morpholinyl, tetrahydrofuryl. Preference is given to pyrimidinyl and triazinyl. Suitable substituents for a substituted heterocyclic radical are the substituents mentioned further below, and additionally also oxo. The oxo group may also be present at the hetero ring atoms, which may exist in different oxidation states, for example in the case of N and S.

Substituted radicals, such as substituted hydrocarbon radicals, for example substituted alkyl, alkenyl, alkynyl, aryl, phenyl and benzyl, or substituted heterocyclyl or heteroaryl, are, for example, a substituted radical which is derived from an unsubstituted parent compound, where the substituents are, for example, one or more, preferably 1, 2 or 3, radicals from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl and, in the case of cyclic radicals, also alkyl and haloalkyl, and unsaturated aliphatic radicals which correspond to the saturated hydrocarbon-containing radicals mentioned, such as alkenyl, alkynyl, alkenyloxy, alkynyloxy, etc. Among the radicals with carbon atoms, preference is given to those having 1 to 4 carbon atoms, in particular 1 or 2 carbon atoms. Preference is generally given to substituents from the group consisting of halogen, for example fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Particular preference is given here to the substituents methyl, methoxy and chlorine.

Unsubstituted or substituted phenyl is preferably phenyl which is unsubstituted or mono- or polysubstituted, preferably substituted up to three times, by identical or different radicals, preferably from the group consisting of halogen, (C₁-C₄)-alkyl, (C₁-C₄)-alkoxy, (C₁-C₄)-haloalkyl, (C₁-C₄)-haloalkoxy and nitro, for example o-, m- and p-tolyl, dimethylphenyl, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl. Cycloalkyl is a carbocyclic saturated ring system having preferably 3-6 carbon atoms, for example cyclopropyl, cyclobutyl, cyclopentyl or cyclohexyl.

The carbon skeleton of the carbon-containing radicals, such as alkyl, alkoxy, haloalkyl, haloalkoxy, alkylamino and alkylthio, and of the corresponding unsaturated and/or substituted radicals may in each case be straight-chain or branched. In these radicals, preference is given to the lower carbon skeletons having, for example, 1 to 6 carbon atoms and, in the case of unsaturated groups, 2 to 6 carbon atoms, unless specified otherwise. Alkyl radicals, also in the composite meanings such as alkoxy, haloalkyl, etc., are, for example, methyl, ethyl, n- or isopropyl, n-, iso-, t- or 2-butyl, pentyls, hexyls, such as n-hexyl, isohexyl and 1,3-dimethylbutyl, heptyls, such as n-heptyl, 1-methylhexyl and 1,4-dimethylpentyl; alkenyl and alkynyl radicals have the meaning of the possible unsaturated radicals which correspond to the alkyl radicals; alkenyl is, for example, allyl, 1-methylprop-2-en-1-yl, 2-methyl-prop-2-en-1-yl, but-2-en-1-yl, but-3-en-1-yl, 1-methyl-but-3-en-1-yl and 1-methyl-but-2-en-1-yl; alkynyl is, for example, propargyl, but-2-yn-1-yl, but-3-yn-1-yl, 1-methyl-but-3-yn-1-yl. Halogen is, for example, fluorine, chlorine, bromine or iodine. Haloalkyl, -alkenyl and -alkynyl is alkyl, alkenyl and alkynyl, respectively, which is partially or fully substituted by halogen, preferably by fluorine, chlorine and/or bromine, in particular by fluorine or chlorine, for example CF₃, CHF₂, CH₂F, CF₃CF₂, CH₂FCHCl, CCl₃, CHCl₂, CH₂CH₂Cl; haloalkoxy is, for example, OCF₃, OCHF₂, OCH₂F, CF₃CF₂O, OCH₂CF₃ and OCH₂CH₂Cl; this applies correspondingly to haloalkenyl and other halogen-substituted radicals.

From among the active compounds from the group of the sulfonamides and their salts (component (a)), very particular preference is given to propoxycarbazone and its sodium salt (propoxycarbazone-methyl-sodium), amidosulfuron and its sodium salt (amidosulfuron-methyl-sodium), iodosulfuron-methyl and its sodium salt (iodosulfuron-methyl-sodium), foramsulfuron and its sodium salt, 2-iodo-N-[(4-methoxy-6-methyl-1,3,5-triazin-2-yl)carbamoyl]benzenesulfonamide and its sodium salt, 3-(5,6-dihydro-1,4,2-dioxazin-3-yl)-N-[(4,6-dimethoxypyrimidin-2-yl)carbamoyl]pyridine-2-sulfonamide and its sodium salt and mesosulfuron-methyl and its sodium salt.

The formulations according to the invention comprise the active compounds from the group of the sulfonamides and their salts (component (a)) in general in amounts of from 0.1 to 70% by weight, preferably from 0.3 to 60% by weight, particularly preferably from 0.5 to 50% by weight; here and in the entire description, the term “% by weight” (percent by weight) refers to the relative weight of the component in question based on the total weight of the formulation, unless defined otherwise.

The carrier materials (component (b)) in the formulations according to the invention may be taken from a group which encompasses minerals, carbonates, sulfates and phosphates of alkaline earth metals and alkali metals, such as calcium carbonate, polymeric carbohydrates, tectosilicates, such as precipitated silicas of low absorbency, and natural tectosilicates, such as kaolin.

Typical representatives of suitable carrier materials include ®Agsorb LVM-GA (attapulgite), ®Harborlite 300 (perlite), ®Collys HV (modified starch), ®Omya-Kreide (calcium carbonate; chalk), ®Extrusil (precipitated silica), ®Kaolin Tec 1 (kaolin, aluminum hydrosilicate), ®Steamic 00S (talc, magnesium silicate).

Preference is given here to natural tectosilicates and calcium carbonate types such as ®Omya-Kreide (calcium carbonate; chalk), ®Tec1 (kaolin) and ®Harborlite 300 (perlite), particular preference to natural tectosilicates such as ®Kaolin Tec 1 (kaolin, aluminum hydrosilicate) and ®Harborlite 300 (perlite).

The proportion of the carrier materials in the formulations according to the invention (component (b)) may be 0.1-90% by weight, preferably 5-80% by weight, particularly preferably 10-70% by weight.

The wetting agents are preferably selected from the group of the naphthalenesulfonic acids and the group of the sulfosuccinic acid derivatives and also the salts of these groups (component c). The wetting agents in the formulations and processes according to the invention may be selected from a group which contains on the one hand monoesters and diesters of sulfosuccinic acid and also their salts (sulfosuccinates) and on the other hand alkylated naphthalenesulfonic acids and their salts.

Typical representatives of suitable wetting agents include ®Aerosol OTB (dioctylsulfosuccinate), ®Morwet EFW (alkylated naphthalenesulfonates), ®Nekal BX (alkylated naphthalenesulfonates), ®Galoryl MT 804 (alkylated naphthalenesulfonates).

Preference is given here to the salts of the alkylated naphthalenesulfonic acids and the salts of dioctylsulfosuccinic acid, particular preference to the sodium salts of alkylated naphthalenesulfonates, such as ®Morwet EFW, and the sodium salts of dioctylsulfosuccinic acid, such as ®Aerosol OTB.

The proportion of the wetting agents in the formulations according to the invention (component c) may be 0.1-50% by weight, preferably 0.25-30% by weight, particularly preferably 0.5-30% by weight.

Examples of the further customary auxiliaries and additives (component d) which may be present optionally in the formulations according to the invention include dispersants, disintegrants, antifoams and adhesion promoters.

Suitable dispersants may be selected from the group of ethoxylated triarylphenols, their optionally partial esters with phosphoric acid, lignosulfonic acids, condensation products of aromatic, optionally polycyclic, sulfonic acids (naphthalenesulfonic acid) with formaldehyde, condensation products of optionally polycyclic phenols with formaldehyde and Na sulfite, sulfonic acids of polycyclic aromatics, and also the alkali metal, alkaline earth metal and ammonium salts of these compounds.

Typical representatives of suitable dispersants include ®Soprophor BSU (phosphated triarylphenol ethoxylate), ®Borresperse NA (lignosulfonate), ®Rapidaminreserve D (condensation product of phenol with Na sulfite and formaldehyde), ®Galoryl DT products (condensation product of aromatic sulfonic acids with formaldehyde), ®Morwet D425 (condensation product of naphthalenesulfonic acid and formaldehyde).

Preference is given to condensation products of aromatic sulfonic acids with formaldehyde and the salts thereof, particular preference to the sodium salts of naphthalenesulfonic acids with formaldehyde, such as ®Galoryl DT505 and ®Morwet D425 (both condensation products of naphthalenesulfonic acid and formaldehyde). The fraction of dispersants that may optionally be present in the formulations according to the invention may be 1-50% by weight, preferably 5-30% by weight, particularly preferably 10-20% by weight.

Suitable disintegrants may be selected from the group of modified carbohydrates, such as microcrystalline cellulose, and crosslinked polyvinylpyrrolidones.

Typical representatives of suitable disintegrants include ®Avicel PH 101 (microcrystalline cellulose), ®Agrimer XLF (crosslinked polyvinylpyrrolidone) and ®Disintex 200 (crosslinked polyvinylpyrrolidone).

Preference is given to crosslinked polyvinylpyrrolidones, such as ®Agrimer XLF.

The proportion of disintegrants which may optionally be present in the formulations according to the invention may be 0.1-50% by weight, preferably 0.5-25% by weight, particularly preferably 1-10% by weight.

Suitable antifoams may be selected from the group of the esters of phosphoric acid with lower alcohols, C6-C10 alcohols, silicone surfactants (suspoemulsions of hydrophobicized silica particles in aqueous emulsifiable concentrates based on liquid silicone surfactants), such as polydimethylsiloxane, and also their forms in which they are absorbed on solid carrier material.

Typical representatives of suitable antifoams include ®Rhodorsil 432 (silicone surfactant), butyl phosphate, isobutyl phosphate, n-octanol, ®Wacker ASP15 (polydimethylsiloxane absorbed on solid carrier), ®Antischaum-Mittel SE (polydimethylsiloxane).

Preference is given to suspoemulsions of hydrophobicized silica particles in aqueous emulsifiable concentrates based on liquid silicone surfactants, such as ®Antischaum-Mittel SE (polydimethylsiloxane), and solid antifoams, such as ®Wacker ASP 15 (polydimethylsiloxane).

The active proportion of antifoams which may optionally be present in the formulations according to the invention may be 0.1-10% by weight, preferably 0.3-5% by weight, particularly preferably 0.5-3% by weight.

Suitable adhesion promoters may be selected from the group of polyvinylpyrrolidone (PVP), polyvinyl alcohol, copolymer of PVP and dimethylaminoethyl methacrylate, butylated PVP, copolymer of vinyl chloride and vinyl acetate, Na salt of the copolymer of propenesulfonic acid and partially hydrolyzed vinyl acetate, sodium caseinate, phenolic resins, modified cellulose types.

Typical representatives of suitable adhesion promoters include ®Luviskol (polyvinylpyrrolidone), ®Mowiol (polyvinyl alcohol), ®Tylose (modified cellulose).

Preference is given to polyvinylpyrrolidone products, particular preference to products of low molecular weight, such as ®Luviskol K30.

The proportion of adhesion promoters that may optionally be present in the formulations according to the invention may be 0.5-20% by weight, preferably 1-10% by weight, particularly preferably 3-8% by weight.

The active compounds referred to by the term “safeners”, which may optionally be present as component (e), are to be understood as meaning compounds which are suitable for reducing phytotoxic actions of active crop protection agent compounds, such as herbicides, on crop plants.

Preferred safeners (component (e)) which may optionally be present in the formulations according to the invention are, inter alia: 4-dichloroacetyl-1-oxa-4-azaspiro[4.5]decane (AD-67), 1-dichloroacetylhexahydro-3,3,8a-trimethylpyrrolo[1,2-a]pyrimidin-6(2H)-one (dicyclonon, BAS-145138), 4-dichloroacetyl-3,4-dihydro-3-methyl-2H-1,4-benzoxazine (benoxacor), 1-methylhexyl 5-chloroquinoline-8-oxyacetic acid (cloquintocet-mexyl), α-(cyanomethoxyimino)phenylacetonitrile (cyometrinil), 2,2-dichloro-N-(2-oxo-2-(2-propenylamino)ethyl)-N-(2-propenyl)-acetamide (DKA-24), 2,2-dichloro-N,N-di-2-propenylacetamide (dichlormid), N-(4-methylphenyl)-N′-(1-methyl-1-phenylethyl)urea (dymron), 4,6-dichloro-2-phenyl-pyrimidine (fenclorim), ethyl 1-(2,4-dichlorophenyl)-5-trichloromethyl-1H-1,2,4-triazole-3-carboxylate (fenchlorazole-ethyl), phenylmethyl 2-chloro-4-trifluoromethyl-thiazole-5-carboxylate (flurazole), 4-chloro-N-(1,3-dioxolan-2-ylmethoxy)-α-trifluoro-acetophenonoxime (fluxofenim), 3-dichloroacetyl-5-(2-furanyl)-2,2-dimethyloxazolidine (furilazole, MON-13900), ethyl 4,5-dihydro-5,5-diphenyl-3-isoxazol-carboxylate (isoxadifen-ethyl), diethyl-1-(2,4-dichlorophenyl)-4,5-dihydro-5-methyl-1H-pyrazole-3,5-dicarboxylate (mefenpyr-diethyl), 2-dichloromethyl-2-methyl-1,3-dioxolane (MG-191), 1,8-naphthalic anhydride, α-(1,3-dioxolan-2-ylmethoximino)-phenylacetonitrile (oxabetrinil), 2,2-dichloro-N-(1,3-dioxolan-2-ylmethyl)-N-(2-propenyl)acetamide (PPG-1292), 3-dichloroacetyl-2,2-dimethyloxazolidine (R-28725), 3-dichloroacetyl-2,2,5-trimethyloxazolidine (R-29148), methyl 1-(2-chlorophenyl)-5-phenyl-1H-pyrazole-3-carboxylate, 4-cyclopropylaminocarbonyl-N-(2-methoxybenzoyl)benzenesulfonamide (cyprosulfamide), 4-isopropylamino-carbonyl-N-(2-methoxybenzoyl)benzenesulfonamide and N-(2-methoxybenzoyl)-4-[(methylaminocarbonyl)amino]benzenesulfonamide.

Very particular preference is given to mefenpyr-diethyl, isoxadifen-ethyl, cyprosulfamide, and mefenpyr-diethyl is especially preferred.

The proportion of the safeners (component (e)) which may optionally be present in the formulations according to the invention may be 0.01-50% by weight, preferably 0.1-40% by weight, particularly preferably 5-20% by weight.

In the case of the use of safeners, which may be present optionally in the formulations according to the invention, use is made optionally of specific solvents (component (e-1)), emulsifiers (component (e-2)) and carrier materials (component (e-3)).

Suitable solvents (component (e-1)) for this purpose may be selected from the group of the aromatic and aliphatic hydrocarbons, esters and amides of organic and inorganic acids, aromatic, aliphatic and cycloaliphatic ketones and alcohols.

Typical representatives of suitable solvents are, inter alia, ®Solvesso types (aromatic hydrocarbon), ®Essobayol (aliphatic hydrocarbon), ®Exxate (esters of organic acids), ®Hallcomide (amides of organic acids), acetophenone (aromatic ketone), methyl isobutyl ketone (aliphatic ketone), ®Anon (cyclohexanone: cycloaliphatic ketone).

Preference is given to solvents from the group of the aromatic and aliphatic hydrocarbons, such as, for example, ®Solvesso types (aromatic hydrocarbons), and aromatic hydrocarbons, such as ®Solvesso 200 ND (alkylated naphthalene), are particularly preferred.

The proportion of solvents (component (e-1)) needed optionally for the addition of safener in the formulations according to the invention may be 0.01-50% by weight, preferably 0.5-40% by weight, particularly preferably 5-20% by weight.

Suitable emulsifiers (component (e-2)) may be of anionic and/or nonionic nature and are selected from the group comprising: salts of alkylated aromatic sulfonic acids, optionally alkylated copolymers of alkylene oxides, such as ethylene oxide and propylene oxide (EO/PO), ethoxylated castor oil, fatty-acylated sorbitan ethoxylate, mono- and diglycerides of fatty acids and their salts, fatty acids and their salts, reaction products of optionally aliphatically or aromatically substituted phenols with alkylene oxides, and also, if appropriate, the partial esters of these surfactants with organic acids, such as acetic acid or citric acid, or inorganic acids, such as sulfuric acid or phosphoric acid.

Typical representatives of suitable emulsifiers are, inter alia, ®Phenylsulfonat CA (Ca dodecylbenzenesulfonate), ®Soprophor types (optionally esterified derivatives of tristyrylphenol ethoxylates), ®Emulsogen 3510 (alkylated EO/PO copolymer), ®Emulsogen EL 400 (ethoxylated castor oil), ®Tween types (fatty-acylated sorbitan ethoxylates), ®Calsogen AR 100 (Ca dodecylbenzenesulfonate).

Preference is given to combinations of salts of alkylated aromatic sulfonic acids, such as ®Phenylsulfonat Ca and/or ®Calsogen AR 100, with alkylated copolymers of ethylene oxide and propylene oxide, such as ®Emulsogen 3510.

Particular preference is given to combinations of salts of dodecylbenzenesulfonic acid, such as ®Calsogen AR 100 with alkylated copolymer of ethylene oxide and propylene oxide, such as ®Emulsogen 3510.

The proportion of emulsifiers (component (e-2)) that may optionally be needed for the addition of safener in the formulations according to the invention may be 0.01-25% by weight, preferably 0.5-10% by weight, particularly preferably 1-5% by weight.

Suitable carrier materials (component (e-3)) for this purpose may be selected from the group of the high-absorbency carriers characterized by an absorbency of at least 200 g of dibutyl phthalate per 100 g of carrier material.

Typical representatives of suitable carrier materials include ®Calflo E (calcium silicate) and ®Sipernat products (synthetic precipitated silica of high absorbency).

Preference is given to calcium silicate, such as ®Calflo E, and precipitated silica, such as ®Sipernat 50S.

The proportion of the carrier materials (component (e-3)) that may optionally be needed for the addition of safener in the formulations according to the invention may be 0.5-30% by weight, preferably 1-20% by weight, particularly preferably 4-10% by weight.

Present as optional agrochemically active compounds (component (f)) may be, for example, agrochemically active compounds different from the components (a) and (e), such as herbicides, fungicides, insecticides, plant growth regulators and the like.

Suitable active compounds different from components (a) and (e) are preferably herbicidally active compounds. These include herbicides from the group of the carbamates, thiocarbamates, haloacetanilides, substituted phenoxy-naphthoxy- and phenoxyphenoxycarboxylic acid derivatives and also heteroaryloxyphenoxyalkane-carboxylic acid derivatives, such as quinolyloxy-, quinoxalyloxy-, pyridyloxyl-, benzoxazolyloxy- and benzothiazolyloxyphenoxyalkanecarboxylic esters, cyclohexanedione derivatives, phosphorus-containing herbicides, of the glufosinate type or of the glyphosate type, for example, and also S—(N-aryl-N-alkylcarbamoyl-methyl)dithiophosphoric esters.

Suitable agrochemically active compounds (component (f)) (which are different from components (a) and (e) and may or may not be present) for the formulations according to the invention are with particular preference, for example, the known active compounds listed below, as described, for example, in Weed Research 26, 441-445 (1986), or in “The Pesticide Manual”, 12th edition (2000), The British Crop Protection Council, and the literature cited therein, for example in formulated mixtures or as components for tank mixes. The compounds are referred to either by the “common name” according to the International Organization for Standardization (ISO) or by the chemical name, if appropriate together with a customary code number, and include in each case all use forms, such as acids, salts, esters and isomers, such as stereoisomers and optical isomers:

acetochlor, acibenzolar, acibenzolar-5-methyl, acifluorfen, acifluorfen-sodium, aclonifen, alachlor, allidochlor, alloxydim, alloxydim-sodium, ametryn, amicarbazone, amidochlor, amidosulfuron, aminocyclopyrachlor, aminopyralid, amitrole, ammoniumsulfamat, ancymidol, anilofos, asulam, atrazine, azafenidin, aziprotryn, beflubutamid, benazolin, benazolin-ethyl, bencarbazone, benfluralin, benfuresate, bensulide, bentazone, benzfendizone, benzobicyclon, benzofenap, benzofluor, benzoylprop, bicyclopyrone, bifenox, bilanafos, bilanafos-sodium, bispyribac, bispyribac-sodium, bromacil, bromobutide, bromofenoxim, bromoxynil, bromuron, buminafos, busoxinone, butachlor, butafenacil, butamifos, butenachlor, butralin, butroxydim, butylate, cafenstrole, carbetamide, carfentrazone, carfentrazone-ethyl, chlomethoxyfen, chloramben, chlorazifop, chlorazifop-butyl, chlorbromuron, chlorbufam, chlorfenac, chlorfenac-sodium, chlorfenprop, chlorflurenol, chlorflurenol-methyl, chloridazon, chlormequat-chloride, chlornitrofen, chlorophthalim, chlorthal-dimethyl, chlorotoluron, cinidon, cinidon-ethyl, cinmethylin, clethodim, clodinafop, clodinafop-propargyl, clofencet, clomazone, clomeprop, cloprop, clopyralid, cloransulam, cloransulam-methyl, cumyluron, cyanamide, cyanazine, cyclanilide, cycloate, cycloxydim, cycluron, cyhalofop, cyhalofop-butyl, cyperquat, cyprazine, cyprazole, 2,4-D, 2,4-DB, daimuron/dymron, dalapon, daminozide, dazomet, n-decanol, desmedipham, desmetryn, detosyl-pyrazolate (DTP), diallate, dicamba, dichlobenil, dichlorprop, dichlorprop-P, diclofop, diclofop-methyl, diclofop-P-methyl, diclosulam, diethatyl, diethatyl-ethyl, difenoxuron, difenzoquat, diflufenican, diflufenzopyr, diflufenzopyr-sodium, dimefuron, dikegulac-sodium, dimefuron, dimepiperate, dimethachlor, dimethametryn, dimethenamid, dimethenamid-P, dimethipin, dimetrasulfuron, dinitramine, dinoseb, dinoterb, diphenamid, dipropetryn, diquat, diquat-dibromide, dithiopyr, diuron, DNOC, eglinazine-ethyl, endothal, EPTC, esprocarb, ethalfluralin, ethephon, ethidimuron, ethiozin, ethofumesate, ethoxyfen, ethoxyfen-ethyl, etobenzanid, F-5331, i.e., N-[2-chloro-4-fluoro-5-[4-(3-fluoropropyl)-4,5-dihydro-5-oxo-1H-tetrazol-1-yl]phenyl]ethanesulfonamide, F-7967, i.e., 3-[7-chloro-5-fluoro-2-(trifluoromethyl)-1H-benzimidazol-4-yl]-1-methyl-6-(trifluoromethyl)pyrimidine-2,4(1H,3H)-dione, fenoprop, fenoxaprop, fenoxaprop-P, fenoxaprop-ethyl, fenoxaprop-P-ethyl, fenoxasulfone, fentrazamide, fenuron, flamprop, flamprop-M-isopropyl, flamprop-M-methyl, florasulam, fluazifop, fluazifop-P, fluazifop-butyl, fluazifop-P-butyl, fluazolate, fluchloralin, flufenacet (thiafluamide), flufenpyr, flufenpyr-ethyl, flumetralin, flumetsulam, flumiclorac, flumiclorac-pentyl, flumioxazin, flumipropyn, fluometuron, fluorodifen, fluoroglycofen, fluoroglycofen-ethyl, flupoxam, flupropacil, flupropanate, flurenol, flurenol-butyl, fluridone, fluorochloridone, fluoroxypyr, fluoroxypyr-meptyl, flurprimidol, flurtamone, fluthiacet, fluthiacet-methyl, fluthiamide, fomesafen, forchlorfenuron, fosamine, furyloxyfen, gibberellic acid, glufosinate, glufosinate-ammonium, glufosinate-P, glufosinate-P-ammonium, glufosinate-P-sodium, glyphosate, glyphosate-isopropylammonium, H-9201, i.e., O-(2,4-dimethyl-6-nitrophenyl) O-ethylisopropyl phosphoramidothioate, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e., 1-(dimethoxyphosphoryl)ethyl (2,4-dichlorophenoxy)-acetate, imazamethabenz, imazamethabenz-methyl, imazamox, imazamox-ammonium, imazapic, imazapyr, imazapyr-isopropylammonium, imazaquin, imazaquin-ammonium, imazethapyr, imazethapyr-ammonium, imazosulfuron, inabenfide, indanofan, indaziflam, indoleacetic acid (IAA), 4-indol-3-ylbutyric acid (IBA), ioxynil, ipfencarbazone, isocarbamid, isopropalin, isoproturon, isouron, isoxaben, isoxachlortole, isoxaflutole, isoxapyrifop, KUH-043, i.e., 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, karbutilate, ketospiradox, lactofen, lenacil, linuron, Maleic hydrazide, MCPA, MCPB, MCPB-methyl, -ethyl and -sodium, mecoprop, mecoprop-sodium, mecoprop-butotyl, mecoprop-P-butotyl, mecoprop-P-dimethylammonium, mecoprop-P-2-ethylhexyl, mecoprop-P-potassium, mefenacet, mefluidide, mepiquat-chloride, mesotrione, methabenzthiazuron, metam, metamifop, metamitron, metazachlor, metazasulfuron, methazole, methiopyrsulfuron, methiozolin, methoxyphenone, methyldymron, 1-methylcyclopropen, methyl isothiocyanate, metobenzuron, metobromuron, metolachlor, S-metolachlor, metosulam, metoxuron, metribuzin, molinate, monalide, monocarbamide, monocarbamide-dihydrogensulfate, monolinuron, monosulfuron, monosulfuron-ester, monuron, MT-128, i.e., 6-chloro-N-[(2E)-3-chloroprop-2-en-1-yl]-5-methyl-N-phenylpyridazin-3-amine, MT-5950, i.e., N-[3-chloro-4-(1-methylethyl)phenyl]-2-methylpentanamide, NGGC-011, naproanilide, napropamide, naptalam, NC-310, i.e., 4-(2,4-dichlorobenzoyl)-1-methyl-5-benzyloxypyrazole, neburon, nipyraclofen, nitralin, nitrofen, nitrophenolat-sodium (isomer mixture), nitrofluorfen, nonanoic acid, norflurazon, orbencarb, orthosulfamuron, oryzalin, oxadiargyl, oxadiazon, oxaziclomefone, oxyfluorfen, paclobutrazol, paraquat, paraquat-dichloride, pelargonic acid (nonanoic acid), pendimethalin, pendralin, penoxsulam, pentanochlor, pentoxazone, perfluidone, pethoxamid, phenisopham, phenmedipham, phenmedipham-ethyl, picloram, picolinafen, pinoxaden, piperophos, pirifenop, pirifenop-butyl, pretilachlor, probenazole, profluazol, procyazine, prodiamine, prifluraline, profoxydim, prohexadione, prohexadione-calcium, prohydrojasmone, prometon, prometryn, propachlor, propanil, propaquizafop, propazine, propham, propisochlor, propyrisulfuron, propyzamide, prosulfalin, prosulfocarb, prynachlor, pyraclonil, pyraflufen, pyraflufen-ethyl, pyrasulfotole, pyrazolynate (pyrazolate), pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, saflufenacil, secbumeton, sethoxydim, siduron, simazine, simetryn, SN-106279, i.e., methyl (2R)-2-({7-[2-chloro-4-(trifluoromethyl)phenoxy]-2-naphthyl}oxy)propanoate, sulcotrione, sulfallate (CDEC), sulfentrazone, sulfometuron, sulfosate (glyphosate-trimesium), SYN-523, SYP-249, i.e., 1-ethoxy-3-methyl-1-oxobut-3-en-2-yl 5-[2-chloro-4-(trifluoromethyl)phenoxy]-2-nitrobenzoate, SYP-300, i.e., 1-[7-fluoro-3-oxo-4-(prop-2-yn-1-yl)-3,4-dihydro-2H-1,4-benzoxazin-6-yl]-3-propyl-2-thioxoimidazolidine-4,5-dione, tebutam, tebuthiuron, tecnazene, tefuryltrione, tembotrione, tepraloxydim, terbacil, terbucarb, terbuchlor, terbumeton, terbuthylazine, terbutryn, thenylchlor, thiafluamide, thiazafluoron, thiazopyr, thidiazimin, thidiazuron, thiobencarb, tiocarbazil, topramezone, tralkoxydim, triallate, triaziflam, triazofenamide, trichloroacetic acid (TCA), triclopyr, tridiphane, trietazine, trifluralin, trimeturon, trinexapac, trinexapac-ethyl, tritosulfuron, tsitodef, uniconazole, uniconazole-P, vernolate, ZJ-0862, i.e., 3,4-dichloro-N-{2-[(4,6-dimethoxypyrimidin-2-yl)oxy]benzyl}aniline, and also the following compounds:

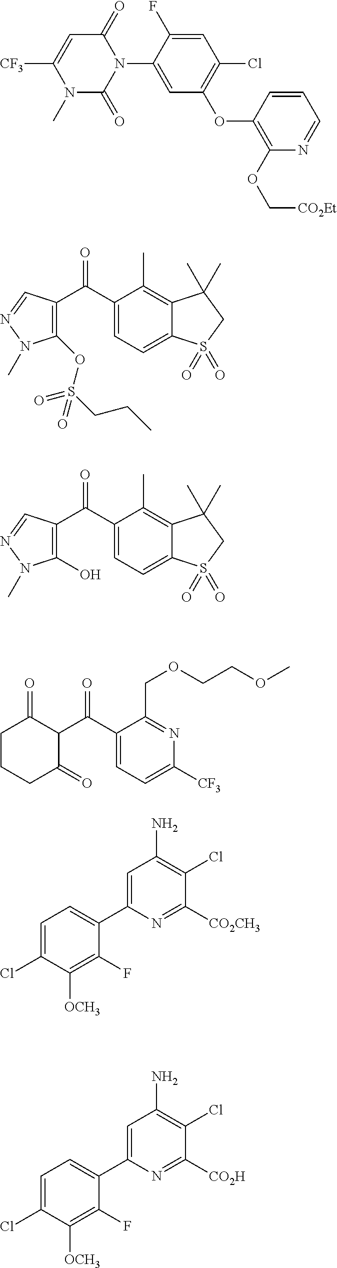

The proportion of the agrochemically active compounds (component (f)) which are different from components (a) and (e) and which may optionally be present in the formulations according to the invention may be 0.1-70% by weight, preferably 0.3-50% by weight, particularly preferably 0.5-30% by weight.

The invention furthermore relates to a herbicidal composition which may be prepared from the formulations according to the invention by dilution with liquids, preferably water.

It may be advantageous to add to the herbicidal compositions obtained in this manner further active compounds, preferably agrochemically active compounds (for example as tank mixing partners in the form of corresponding formulations) and/or auxiliaries and additives customary for application, for example self-emulsifying oils, such as vegetable oils or paraffin oils, and/or fertilizers. Accordingly, the present invention also relates to the preferably herbicidal compositions of this kind, based on the formulations according to the invention.

One particular embodiment of the invention relates to the use of the herbicidal compositions, obtainable from the formulations according to the invention, for controlling unwanted vegetation, hereinbelow referred to as “herbicidal composition”.

The herbicidal compositions have outstanding herbicidal activity against a broad spectrum of economically important monocotyledonous and dicotyledonous harmful plants. Even perennial weeds which produce shoots from rhizomes, rootstocks or other perennial organs and which are difficult to control are controlled well. In this context, it does not matter whether the herbicidal compositions are applied before sowing, pre-emergence or post-emergence. Specific examples may be mentioned of some representatives of the monocotyledonous and dicotyledonous weed flora which can be controlled by the herbicidal compositions, without the enumeration being a restriction to certain species.

Examples of weed species on which the herbicidal compositions act efficiently are, from amongst the monocotyledonous weed species, Apera spica venti, Avena spp., Alopecurus spp., Brachiaria spp., Digitaria spp., Lolium spp., Echinochloa spp., Panicum spp., Phalaris spp., Poa spp., Setaria spp. and Bromus spp. such as Bromus catharticus, Bromus secalinus, Bromus erectus, Bromus tectorum and Bromus japonicus, and Cyperus species from the annual group, and, among the perennial species, Agropyron, Cynodon, Imperata and Sorghum and also perennial Cyperus species. In the case of the dicotyledonous weed species, the spectrum of action extends to genera such as, for example, Abutilon spp., Amaranthus spp., Chenopodium spp., Chrysanthemum spp., Galium spp. such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., among the annuals, and Convolvulus, Cirsium, Rumex and Artemisia in the case of the perennial weeds.

The herbicidal compositions also give outstanding control of harmful plants which are found under the specific conditions of culture in rice, such as, for example, Echinochloa, Sagittaria, Alisma, Eleocharis, Scirpus and Cyperus.

If the herbicidal compositions are applied to the soil surface before germination, the weed seedlings are either prevented completely from emerging or else the weeds grow until they have reached the cotyledon stage, but then their growth stops, and, eventually, after three to four weeks have elapsed, they die completely.

If the herbicidal compositions are applied post-emergence to the green parts of the plants, growth likewise stops drastically a very short time after the treatment, and the weed plants remain at the growth stage of the point of time of application, or they die completely after a certain time, so that in this manner competition by the weeds, which is harmful to the crop plants, is eliminated very early and in a sustained manner.

The herbicidal compositions are distinguished by a rapidly commencing and long-lasting herbicidal action. As a rule, the rainfastness of the active substances in the herbicidal compositions is advantageous. A particular advantage is that the dosages used in the herbicidal compositions and the effective dosages of herbicidal compounds can be adjusted to such a low level that their soil action is optimally low. This does not only allow them to be employed in sensitive crops in the first place, but groundwater contaminations are virtually avoided. The active compound combination according to the invention allows the required application rate of the active substances to be reduced considerably.

The abovementioned properties and advantages are necessary for weed control practice to keep agricultural crops free from undesired competing plants, and thus to ensure and/or increase yield levels from the qualitative and quantitative angle. These new herbicidal compositions markedly exceed the technical state of the art with a view to the properties described.

While the herbicidal compositions have an outstanding herbicidal activity against monocotyledonous and dicotyledonous weeds, crop plants of economically important crops, for example dicotyledonous crops such as soya, cotton, oilseed rape, sugarbeet, or graminaceous crops such as wheat, barley, rye, oats, millet, rice or corn, are damaged only to a minor extent, if at all. This is why the present herbicidal compositions are highly suitable for the selective control of undesired plant growth in plantations of agricultural crops or of ornamentals.

In addition, the corresponding herbicidal compositions have outstanding growth-regulatory properties in crop plants. They engage in the plants' metabolism in a regulatory manner and can thus be employed for provoking direct effects on plant constituents and to facilitate harvesting such as, for example, by triggering desiccation and stunted growth. Moreover, they are also suitable for the general control and inhibition of undesired vegetative growth without simultaneously destroying the plants. Inhibition of vegetative growth is very important in a large number of monocotyledonous and dicotyledonous crops since lodging can thus be reduced, or prevented completely.

Owing to their herbicidal and plant-growth-regulatory properties, the herbicidal compositions can also be employed for controlling harmful plants in crops of genetically modified plants which are known or yet to be developed. As a rule, the recombinant plants are distinguished by specific advantageous characteristics, for example by resistances to certain pesticides, in particular certain herbicides, resistances to plant diseases or the causative organisms of plant diseases such as specific insects or microorganisms such as fungi, bacteria or viruses. Other specific characteristics relate, for example, to the harvested material with regard to quantity, quality, storability, composition and specific constituents. Thus, for example, transgenic plants are known whose starch content is increased, or whose starch quality is altered, or those where the harvested material has a different fatty acid composition.

The use of the herbicidal compositions in economically important transgenic crops of useful plants and ornamentals, for example of graminaceous crops such as wheat, barley, rye, oats, millet, rice and corn, or else crops of sugarbeet, cotton, soya, oilseed rape, potatoes, tomatoes, peas and other vegetables, is preferred. Preferably, the herbicidal compositions can be employed in crops of useful plants which resist the phytotoxic effects of the herbicides, or have been made to resist these effects by recombinant techniques.

When using the herbicidal compositions in transgenic crops, effects are frequently observed in addition to the effects against harmful plants to be observed in other crops, which are specific for the application in the transgenic crop in question, for example a modified or specifically widened weed spectrum which can be controlled, modified application rates which may be employed for application, preferably good combining ability with the further herbicidally active compounds to which the transgenic crop is resistant, and an effect on growth and yield level of the transgenic crop plants.

The present invention therefore also relates to a method for controlling undesired vegetation, preferably in crops of plants such as cereals (for example wheat, barley, rye, oats, rice, corn and millet), sugar beet, sugar cane, oilseed rape, cotton and soya, especially preferred in monocotyledonous plants such as cereals, for example wheat, barley, rye, oats, and their hybrids such as triticale, rice, corn and millet, wherein the herbicidal compositions according to the invention are applied to the harmful plants, plant parts, seeds of the plants or the area on which the plants grow, for example the area under cultivation.

The plant crops may also be genetically modified or have been obtained by mutation selection; they preferably tolerate acetolactate synthase (ALS) inhibitors.

The formulations according to the invention also have excellent chemical stability during preparation and storage and are suitable in particular also for combinations of active compounds having different physicochemical properties. The formulations according to the invention likewise have excellent physical stability, are easy to apply and to use and have high biological effectiveness and selectivity.

Altogether, the formulations according to the invention have the desired long-term storage stability and can be employed without any problems.

### EXAMPLES

The examples serve to illustrate the invention and do not limit the processes and compounds described therein.

### Preparation Process:

The individual components are dissolved or dispersed in water in the respective proportions. The resulting mixture is converted using a fluidized bed granulator into water-soluble granules, which following granulation still have a predetermined residual water content.

The examples shown in Tables 2 to 5 were prepared using the stated preparation process (residual water content: approximately 1% by weight).

TABLE 1
Description of the products used in the examples:

| | |
|---|---|
| Kaolin ® Tec 1 | Carrier material, low absorbency (kaolin, |
| | aluminum hydrosilicate), Ziegler & Co. |
| Texapon ® K12 | Wetting agent, alkyl sulfate type (Na lauryl |
| | sulfate), Cognis |
| Luvitec ® K30 | Binder (polyvinylpyrrolidone), BASF |
| Solvesso ® 200ND | Aromatic solvent (alkylated naphthalene), Exxon |
| Emulsogen ® 3510 | Emulsifier, nonionic (alkylated EO/PO block |
| | copolymer), Clariant |
| Sipernat ® 50S | Carrier material, high absorbency (precipitated |
| | silica), Degussa |
| Galoryl ® DT530 | Dispersant, condensed naphthalenesulfonate type, |
| | CAS No. 068425-94-5 |
| Silfoam ® SE2 | Antifoam, polydimethylsiloxane type, Wacker |
| Pluronic ® 10500 | Emulsifier, PO-EO block polymer type, BASF |
| Phenylsulfonat ® Ca | Emulsifier, alkarylsulfonate type, Clariant |

TABLE 2

| Ingredient | Amount/g | Remark |
|---|---|---|
| Iodosulfuron methyl | 0.6 | Component (a) |
| Mesosulfuron methyl | 3.0 | Component (a) |
| Kaolin ® | 34.1 | Component (b) |
| Texapon ® K12 | 6.0 | Component (c) |
| Galoryl ® DT530 | 10.0 | Component (d) |
| Luvitec ® K30 | 5.0 | Component (d) |
| Silfoam ® SE2 | 5.0 | Component (d) |
| Mefenpyr Diethyl | 9.0 | Component (e) |
| Solvesso ® 200 ND | 16.6 | Component (e-1) |
| Pluronic ® 10500 | 1.5 | Component (e-2) |
| Phenylsulfonat ® Ca | 1.5 | Component (e-2) |
| Sipernat ® 50S | 12.0 | Component (e-3) |
| Aqueous sodium | variable | As needed for pH adjustment |
| hydroxide, 50% | | |
| Water | ad 200 | |

TABLE 3

| Ingredient | Amount/g | Remark |
|---|---|---|
| Amidosulfuron | 5.0 | Component (a) |
| Iodosulfuron methyl | 1.2 | Component (a) |
| Kaolin ® | 31.7 | Component (b) |
| Texapon ® K12 | 5.0 | Component (c) |
| Galoryl ® DT530 | 12.0 | Component (d) |
| Luvitec ® K30 | 2.0 | Component (d) |
| Silfoam ® SE2 | 5.0 | Component (d) |
| Mefenpyr Diethyl | 12.5 | Component (e) |
| Solvesso ® 200 ND | 15.0 | Component (e-1) |
| Pluronic ® 10500 | 1.5 | Component (e-2) |
| Phenylsulfonat ® Ca | 1.5 | Component (e-2) |
| Sipernat ® 50S | 10.0 | Component (e-3) |
| Aqueous sodium | variable | As needed for pH adjustment |
| hydroxide, 50% | | |
| Water | ad 200 | |

TABLE 4

| Ingredient | Amount/g | Remark |
|---|---|---|
| Sodium salt of 3-(5,6-dihydro-1,4,2- | 15.0 | Component (a) |
| dioxazin-3-yl)-N-[(4,6- | | |
| dimethoxypyrimidin-2- | | |
| yl)carbamoyl]pyridine-2-sulfonamide | | |
| Iodosulfuron methyl | 2.4 | Component (a) |
| Kaolin ® | 67.7 | Component (b) |
| Texapon ® K12 | 2.0 | Component (c) |
| Galoryl ® DT530 | 10.0 | Component (d) |
| Luvitec ® K30 | 2.0 | Component (d) |
| Silfoam ® SE2 | 4.2 | Component (d) |
| Aqueous sodium hydroxide, 50% | variable | As needed for pH |
| | | adjustment |
| Water | ad 200 | |

TABLE 5

| Ingredient | Amount/g | Remark |
|---|---|---|
| Sodium salt of 2-iodo-N-[(4-methoxy-6- | 8.0 | Component (a) |
| methyl-1,3,5-triazin-2-yl)carbamoyl]- | | |
| benzenesulfonamide | | |
| Iodosulfuron methyl | 2.9 | Component (a) |
| Kaolin ® | 20.9 | Component (b) |
| Texapon ® K12 | 6.0 | Component (c) |
| Galoryl ® DT530 | 10.0 | Component (d) |
| Luvitec ® K30 | 5.0 | Component (d) |
| Silfoam ® SE2 | 5.0 | Component (d) |
| Mefenpyr Diethyl | 15.0 | Component (e) |
| Solvesso ® 200 ND | 16.6 | Component (e-1) |
| Pluronic ® 10500 | 1.5 | Component (e-2) |
| Phenylsulfonat ® Ca | 1.5 | Component (e-2) |
| Sipernat ® 50S | 12.0 | Component (e-3) |
| Aqueous sodium hydroxide, 50% | variable | As needed for pH |
| | | adjustment |
| Water | ad 200 | |

1. A process for preparing a herbicidal, water-dispersible solids formulation, said process comprising:
A) preparing a suspension comprising components (a) to (d):
(a) at least one active compound selected from the group consisting of sulfonamides and salts thereof,
(b) at least one carrier material,
(c) at least one wetting agent,
(d) at least one further auxiliary and/or additive,
B) setting a desired pH level in the suspension by adding a base, and
C) drying the suspension,
wherein the pH level being set in B) is to a level of 8.1 to 10, and the suspension contains no tritosulfuron.

2. The process as claimed in claim 1, wherein the suspension prepared in A further comprises at least one safener.

3. The process as claimed in claim 2, wherein the suspension prepared in (A) further comprises solvents, emulsifiers and/or carrier materials needed for the addition of said safener.

4. The process as claimed in claim 1, wherein the suspension prepared in (A) further comprises at least one agrochemically active compound different from said at least one active compound (a) selected from the group consisting of sulfonamides and salts thereof.

5. The process as claimed in claim 1, wherein the wetting agent (c) is selected from the group consisting of naphthalenesulfonic acids and sulfosuccinic acid derivatives and salts thereof.

6. The process as claimed in claim 2, wherein the suspension prepared in (A) further comprises at least one agrochemically active compound different from said at least one active compound (a) selected from the group consisting of sulfonamides and salts thereof, and said safener.

7. The process as claimed in claim 3, wherein the suspension prepared in A further comprises at least one agrochemically active compound different from said at least one active compound (a) selected from the group consisting of sulfonamides and salts thereof, and said safener.

8. The process as claimed in claim 2, wherein the wetting agent (c) is selected from the group consisting of naphthalenesulfonic acids and sulfosuccinic acid derivatives and salts thereof.

9. The process as claimed in claim 3, wherein the wetting agent (c) is selected from the group consisting of naphthalenesulfonic acids and sulfosuccinic acid derivatives and salts thereof.

10. The process as claimed in claim 4, wherein the wetting agent (c) is selected from the group consisting of naphthalenesulfonic acids and sulfosuccinic acid derivatives and salts thereof.
